(19) United States
(12) Patent Application Publication
(10) Pub. No.: US 2021/0387371 A1
(43) Pub. Date: Dec. 16, 2021

(54) METHOD AND DEVICE FOR COATING A WORKPIECE

(71) Applicant: HOMAG GmbH, Schopfloch (DE)

(72) Inventors: Sergej SCHWARZ, Nürnberg (DE); Johannes SCHMID, Starzach (DE)

(21) Appl. No.: 17/291,595

(22) PCT Filed: Sep. 19, 2019
(86) PCT No.: PCT/EP2019/075164

§ 371 Date: May 5, 2021

(30) Foreign Application Priority Data
Nov. 6, 2018 (DE) 10 2018 127 617.6

(51) Int. Cl. B27D 5/00; C09J 5/06; C09J 5/04

(52) U.S. Cl. CPC B27D 5/003; C09J 2400/22; C09J 5/04; C09J 5/06

(57) ABSTRACT

Method for coating a workpiece which preferably consists at least in sections of wood, wood-based materials, plastic or the like, comprising the steps of: supplying a coating material to a surface to be coated of the workpiece, and bonding the coating material to the surface to be coated using a bonding agent.

### TECHNICAL FIELD

The invention relates to a method for coating a workpiece which preferably consists at least in sections of wood, wood-based materials, plastic or the like, and to a device for coating a workpiece.

### PRIOR ART

In the furniture and components industry, providing plate-shaped workpieces with a coating material (edging material) in the region of their narrow surface is known. Two basic techniques are primarily used for this: namely gluing by means of a hot-melt adhesive that is rolled on in the course of the bonding process, and supplying a coating material provided with a bonding agent and activating the bonding agent in the course of the bonding process by means of an appropriate energy source.

The first of the aforementioned techniques has the disadvantage that rolling on the hot-melt adhesive is laborious and results in impurities in the machine. Moreover, only a limited bonding quality can be achieved when rolling on hot-melt adhesives.

Bonding pre-coated edges using energy sources is disclosed in DE 199 55 575 A1, for example, and has proven successful in practice. However, this technique often requires high machinery investment since the energy sources required, such as lasers, hot air assemblies, microwave generators or ultrasound sources, are associated with high costs. Furthermore, these energy sources require a large amount of space and sometimes result in a high amount of heat input into the respective device.

### DESCRIPTION OF THE INVENTION

The invention is therefore based on the object of providing a method and a device of the type described above which, with a simple design and a quick procedure, facilitate a bonding process with high-quality bonding.

According to the invention, this object is achieved by a method for coating a workpiece as according to claim 1 and by a device for coating a workpiece as according to claim 17. Particularly preferred embodiments of the invention are described in the dependent claims.

Since the method according to the invention requires neither rolling on hot-melt adhesive nor the use of an energy source, the disadvantages associated therewith are eliminated. The result is therefore a quick coating process which can be realized with a simple design and which leads to a high-quality bonding result.

To realize this concept, various approaches can be used, which are set out in the dependent claims. For instance, provision is made according to one development of the invention for the bonding agent to comprise at least two components, wherein the adhesiveness of the bonding agent is increased by combining the components. Thanks to this concept, the use of an energy source can be omitted since a sufficient adhesiveness of the bonding agent can be achieved by combining the components during the bonding process. In this regard it should be noted that at least one bonding agent component may already have a certain adhesiveness even before the components are combined, which allows a sufficient initial adhesion of the coating material to the workpiece, for example. Thanks to this concept, an energy source can be omitted, which drastically simplifies the design of the required device. At the same time, components of a bonding agent can be handled and applied considerably more easily than previously used hot-melt adhesives. The layer thickness of such components can also be considerably thinner than a rolled-on hot-melt adhesive layer, and therefore the join between the workpiece and coating material can be minimized, with corresponding optical and technical advantages such as also increased impermeability to moisture, etc.

In the context of the invention, the bonding agent components are not particularly limited. However, at least one first bonding agent component advantageously comprises a resin, in particular synthetic resin. As a result, a high strength and durability of the bond can be achieved.

A variety of substances, optionally in combination, can be considered as the second bonding agent component. According to one development of the invention, at least one second component is selected from gas, such as, in particular, air, moisture, hardener and combinations thereof. It may therefore be sufficient for the ambient air, which is present in any case, or the moisture which is present in any case in the ambient air and/or the workpiece, to act as the second component. However, the second component may also be actively provided, for example by way of an air or moisture blower, or by applying moisture or a hardener onto the workpiece or coating material. As a result, the bonding process can be controlled in a targeted manner.

Although the invention intends to eliminate the disadvantages associated with the conventional rolling-on of hot-melt adhesive, another use of hot-melt adhesive or other thermally activatable bonding agents is a subject matter of the invention since such bonding agents have proven successful in view of their bonding properties. Against this background, the bonding agent or at least one bonding agent component may comprise a thermally activatable adhesive such as, in particular, a hot-melt adhesive, which is preferably selected from thermoplastic polyurethane, EVA, polyolefin, polypropylene, polyamide and polyacrylate.

According to one development of the invention, at least one bonding agent component, in particular the second bonding agent component, is applied to the surface to be coated of the workpiece and/or the surface to be bonded of the coating material. The method therefore offers full flexibility and can be adapted to the properties of the materials to be bonded as required. This also results in a reliable bonding process and a high-quality bond.

Although the bonding agent or bonding agent components can be provided in a variety of ways, as already mentioned above, for example also simply by supplying gas or air, provision is made according to one development of the invention for the bonding agent or at least one bonding agent component, in particular the first bonding agent component, to be supplied as a web-shaped or strip-shaped material. As a result, a laborious and impurity-intensive application of glue can be omitted as compared to the known hot-melt adhesive method. The advantage over pre-coated edges is that a considerably greater variety of edges can be used and that it is possible to work with much simpler edges. Overall, the result is a quick and flexibly adaptable procedure thanks to the web-shaped or strip-shaped material.

Alternatively or additionally to the multi-component concept described above, provision is made according to one development of the invention for the bonding agent to be made adhesive by mechanical force, in particular by the application of pressure. In the context of this concept, it is also possible that the bonding agent will already have a certain adhesiveness and obtains increased adhesiveness by way of mechanical force. In any case, this concept produces the desired adhesiveness with minimal effort at the ideal time, which results in a completely new type of bonding process with high-quality bonding results. The mechanical force may for example be provided while pressing the coating material onto the workpiece, such that an additional component for activating or increasing the adhesiveness of the bonding agent is not required. To achieve this effect, the bonding agent may comprise appropriate, pressure-sensitive substances or repositories such as capsules, which are activated or released with mechanical force (here: the application of pressure), thereby increasing the adhesiveness of the bonding agent or allowing it to develop in the first place.

In the case of a further concept according to the invention, provision is made according to one development for the bonding agent or at least one bonding agent component to be stored in an adhesive state and supplied to the bonding process. Also with this concept, both an energy source and heating or other type of activating the bonding agent can be omitted entirely or at least in part, with the corresponding advantages as already described above.

It is particularly preferable for the adhesive bonding agent to be provided in the stored state with an anti-adhesion cap, which is removed before the bonding process is carried out. This ensures that the bonding agent—which may be highly adhesive—only develops its adhesive effect in the course of the bonding process and does not bond unintentionally in advance of the bonding process.

Moreover, with this concept it is preferable for the adhesive bonding agent to be provided on the surface to be bonded of the coating material or as a separate web-shaped or strip-shaped material.

In the case of a further concept of the present invention, which can optionally be combined with the aforementioned concepts as required, provision is made for the bonding agent or at least one bonding agent component to be applied to the surface to be bonded of the coating material and/or to the surface to be coated of the workpiece by means of a drop-on-demand method. This results in a plurality of advantages. For instance, the bonding agent can be applied to the surface to be bonded of the coating material and/or to the surface to be coated of the workpiece in a particularly targeted manner. In this way, not only the layer thickness of the bonding agent but optionally also the distribution of the bonding agent can be optimally adapted to the respective requirements. For example, a particularly continuous bonding agent layer can be provided at the edges of the respective bonding region in order to achieve a desired imperviousness. Alternatively, it is possible to work with an increased layer thickness also in the central regions, particularly in the case of porous workpieces. Furthermore, the coloring of the bonding agent may in some circumstances be adapted to the respective requirements, for example in order to adapt the color of a join that may to a small extent still be visible to the surface color of the coating material and/or the workpiece. To this end, a plurality of differently colored bonding agents can be provided, the mixing ratio of which being capable of setting practically any color. Once again, an energy source is not required with this concept, and the aforementioned disadvantages of applying a hot-melt adhesive are not present either. Instead, the result is a very precise, usually thin, adjustable bonding agent layer, which leads to an excellent bonding result with minimal effort.

According to one development of the invention, provision is made for the bonding agent or at least one bonding agent component to have a temperature of at least 70° C., preferably a temperature of at least 80° C., particularly preferably a temperature of at least 90° C., upon application. This results in a particularly high bonding quality, and a wide variety of thermally activatable bonding agents or bonding agent components can be used. Moreover, it results in a quick bonding process and a good workability of the bonding agent or bonding agent components.

Alternatively or additionally, provision is made according to one development of the invention for the bonding agent or at least one bonding agent component to have a viscosity of at least 30 mPa s, preferably at least 50 mPa s and/or at most 800 mPa s, preferably at most 500 mPa s, upon application. By setting the viscosity of the bonding agent or at least one bonding agent component in a targeted manner, the layer thickness can be particularly well controlled, and undesirable impurities, agglutinations or other irregularities can be avoided or minimized. At the same time, the targeted setting of the viscosity also allows the drop-on-demand method to be carried out in a quick and uninterrupted manner.

Furthermore, provision is made according to one development of the invention for the bonding agent or at least one bonding agent component to be brought into a web-shaped or strip-shaped form prior to bonding and subsequently, in the course of the further bonding process, to no longer be supplied with energy, in particular to no longer be supplied with thermal energy. In this way, according to the invention the use of a separate energy source such as a laser or a hot air assembly can be dispensed with since the bonding agent or bonding agent component that is present in a web-shaped or strip-shaped form can be immediately processed or used for bonding. This results in a considerably simplified bonding process and a considerably simplified design of a device required for this purpose, but still with a high-quality bond.

Alternatively or additionally, provision is made according to one development of the invention for the bonding agent or at least one bonding agent component to be brought into a web-shaped or strip-shaped form prior to bonding, which form has a mass per unit area of at most 150 g/m2, preferably at most 120 g/m2, particularly preferably at most 100 g/m2. As a result of these low masses per unit area, it is possible to create a barely visible join which nevertheless has a high level of resistance (for example to the removal of the coating material). The bonding agent join between the workpiece and the coating material can almost no longer be perceived, which results in an excellent appearance of the finished workpiece.

The aforementioned advantages can be advantageously achieved with a device for coating a workpiece as according to claim 17. Preferably, the device according to the invention comprises a drop-on-demand application unit (hereinafter referred to as the “DoD application unit”), which is configured to apply the bonding agent or at least one bonding agent component to the surface to be bonded of the coating material and/or the surface to be coated of the workpiece by means of a drop-on-demand method. As a result, the advantages set out above for a DoD method can be particularly effectively achieved.

In the context of the present invention, the DoD application unit can be configured in a wide variety of ways and can comprise a wide range of components. According to one development of the invention, however, provision is made for the DoD application unit to comprise at least one microactuator, in particular a piezo actuator, for discharging the bonding agent or at least one bonding agent component. This results in a particularly precise dosability of the bonding agent, with a long service life and easy cleanability at the same time.

According to one development of the invention, provision is also made for the DoD application unit to comprise a liquefaction means, in particular heating means, which is configured to increase the viscosity of the bonding agent or at least one bonding agent component. In this way, the aforementioned advantages of the viscosity and temperature of the bonding agent being able to be set in a targeted manner can be utilized in a simple and effective manner. The integration of a liquefaction means in the DoD application unit contributes to adjusting the bonding agent or the at least one bonding agent component to the desired or optimum viscosity or temperature immediately before application, and therefore the desired result can be achieved with a high degree of reliability and accuracy.

Alternatively or additionally, however, provision is made according to one development of the invention for it to also comprise a liquefaction unit, in particular a heating unit, upstream of the DoD application unit, which is configured to increase the viscosity of the bonding agent or at least one bonding agent component. The separate provision of an upstream liquefaction unit may, firstly, eliminate the need for a liquefaction means in the DoD application unit, such that the design of the DoD application unit is simplified and a wider range of DoD application units can be used. Secondly, an upstream additional liquefaction unit allows a multi-stage liquefaction process, which offers advantages both in terms of the heating time and in terms of a careful and effective liquefaction or heating process.

According to one development of the invention, provision is also made for the device to comprise a sealing means for sealing off the bonding agent or at least one bonding agent component contained in the DoD application unit from the environment. As a result, premature hardening, setting or cooling or other undesirable processes within the bonding agent can be avoided or minimized, such that even longer interruptions to the operation of the DoD application unit are possible without any problems, for example, without negatively impacting the bonding quality or causing longer set-up times.

Although the device according to the invention can in principle work with a single bonding agent, provision is made according to one development of the invention for the device to comprise a mixing means for mixing a plurality of supplied bonding agents or bonding agent components. This results in various possibilities of adapting the bonding agent to be applied using the DoD application unit to the respective requirements, for example by setting the color or consistency or adhesiveness in an optimum manner. In this respect it should be noted that particularly in the case of so-called batch size one production, there may be considerably varying requirements, such as differently colored coating materials, workpieces with greatly varying porosities and changing requirements in terms of join imperviousness or tear resistance of the coating material.

In view of an integrated and interference-free basic concept, provision is made according to one development of the invention for the device to also comprise a supply means for supplying and preferably also storing at least one bonding agent or at least one bonding agent component. This results in a closed system which facilitates complete automation and ongoing control or regulation of the coating process, with corresponding advantages for the efficiency and quality of the bonding process.

In this regard it is particularly preferable for the supply means to supply a plurality of bonding agents or bonding agent components having different properties, in particular different colors and/or different components. As a result, the advantages mentioned above with respect to the mixing means can be achieved particularly easily and reliably. It should be stressed in this respect that particularly the aspect of colored bonding agents or bonding agent components can have particular importance for the creation of a so-called “invisible join”, wherein the bonding agent join between the workpiece and the coating material is almost no longer visible to the naked eye. An important core element for achieving such an invisible join is the adaptation of the color of the bonding agent to that of the coating material and/or the rest of the workpiece surface which the invention makes possible. For this, bonding agents or bonding agent components that are provided in suitable base colors, for example in black, cyan, yellow and magenta, can be used.

According to one development of the invention, provision is also made for the device to comprise a cleaning means, in particular a rinsing means, for the DoD application unit. This ensures a long-lasting and interference-free operation of the DoD application unit and a permanently high quality bond.

### BRIEF DESCRIPTION OF THE DRAWINGS

FIG. 1 schematically shows a first embodiment of the device according to the invention;

FIG. 2 schematically shows a second embodiment of the device according to the invention and a side view of a coating material;

FIG. 3 schematically shows a third embodiment of the device according to the invention;

FIG. 4 schematically shows a fourth embodiment of the device according to the invention;

FIG. 5 schematically shows a fifth embodiment of the device according to the invention;

FIG. 6 schematically shows a detailed view of the device shown in FIG. 5; and

FIG. 7 schematically shows a sixth embodiment of the device according to the invention.

### DETAILED DESCRIPTION OF PREFERRED EMBODIMENTS

In the following, preferred embodiments of the invention will be described in detail with reference to the accompanying drawings.

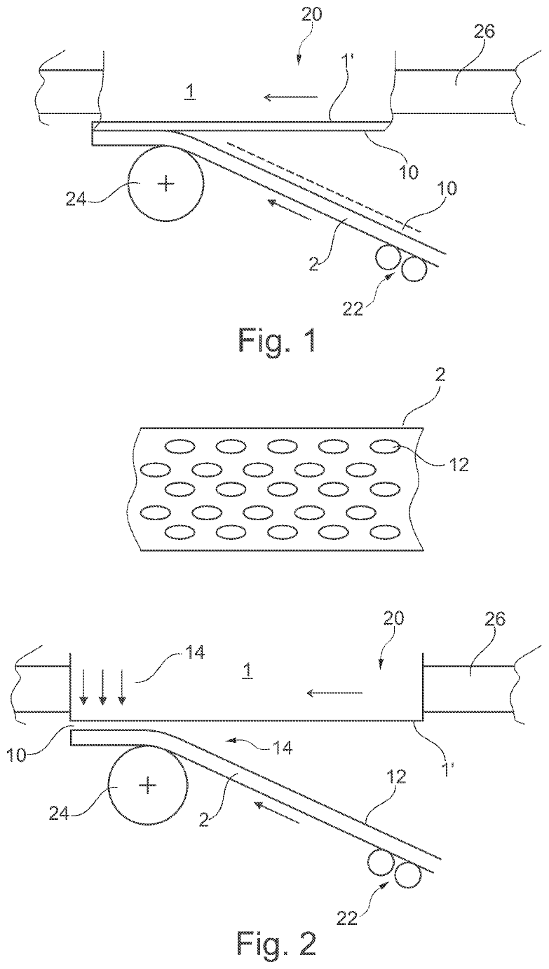

A device 20 for coating a workpiece 1 as according to a first embodiment is schematically shown in FIG. 1 in plan view. The device 20 is used for coating a workpiece 1 which can consist, entirely or in part, of wood, wood-based materials, plastic or similar materials, for example. Such workpieces are widely used in the field of the furniture and components industry and are often provided with a coating material on their narrow and/or wide surfaces, which coating material can fulfil both decorative and technical purposes, such as protection against mechanical loads, moisture, heat and the like.

In the present embodiment, the device 20 comprises a means 22 for supplying a coating material 2 to a surface 1′ to be coated of the workpiece 1, which in the present embodiment comprises a plurality of supply rollers. Furthermore, although not shown in FIG. 1, the supply means 22 may also contain a supply of coating material which may be in the form of one or more rollers or containers, for example. Moreover, the supply means 22 can also be configured to supply, in alternating operation, different coating materials as required, and to this end it may comprise a plurality of supply lines.

Furthermore, the device 20 comprises a means 24 for bonding the coating material 2 to the surface 1′ to be coated using a bonding agent 10, which in the present embodiment comprises one or more pressing rollers 24.

Moreover, the device 20 comprises a conveying means 26 for causing a relative movement between the workpiece 1 and the bonding means 24. In the present embodiment, these are configured as a so-called continuous conveying means, with which the workpieces 1 are conveyed along a bonding means 24 which is stationary or movable within limits. It should be noted, however, that in the context of the present invention other conveying concepts are also possible, such as, for example, so-called stationary machines, with which the workpiece 1 to be coated is arranged in a substantially stationary manner and the bonding apparatus 24 is moved relative to the workpiece 1 (cf. also FIG. 7 in this regard). Combinations of this concept are also possible.

As can be seen from FIG. 1, the coating material 2 is bonded to the surface 1′ to be coated of the workpiece 1 using a bonding agent 10, which can be provided on the surface 1′ to be coated and/or on the facing surface of the coating material 2 as strips or webs, for example. What is decisive here is that the bonding agent 10 is present as strips or webs, such that in the course of the further bonding process it no longer needs to be supplied with energy (such as thermal energy). Accordingly, the device 20 shown in FIG. 1 is also free of a corresponding energy source such as a laser or hot air assembly, for example.

To realize this concept, various bonding agent systems can be considered; some examples of these will be described in the following with reference to FIGS. 2 to 6.

In the embodiment shown in FIG. 2, the bonding agent 10 comprises two bonding agent components 12 and 14, wherein the adhesiveness of the bonding agent 10 formed is increased by combining components 12 and 14. The first bonding agent component 12 may comprise, for example, a resin, in particular synthetic resin. In contrast, a second bonding agent component 14 can be selected from gas, such as, in particular, air, moisture, hardener and combinations thereof. This means that the first bonding agent component 12 can react for example with the ambient air and possibly the moisture contained therein in order to increase the adhesiveness of the bonding agent 10 formed as a result. Alternatively or additionally, it is also possible for the second bonding agent component 14 to be removed from the surface 1′ to be coated of the workpiece 1, for example in the form of moisture, binding agent or hardener, which are present in the workpiece 1. In this regard it should be noted that each of the two bonding partners (coating material 2 and workpiece 1) can be provided with both a first bonding agent component 12 and a second bonding agent component 14 and optionally also further bonding agent components, and that these bonding agent components are either provided separately or they are already intrinsically contained in one or both bonding partners.

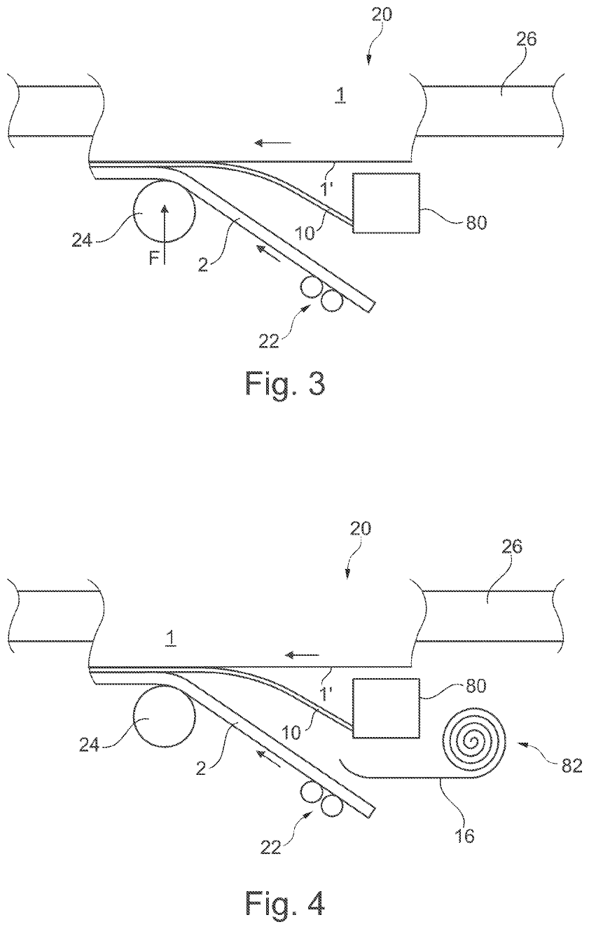

In the embodiment illustrated in FIG. 3, the bonding agent 10 is present as a web-shaped material (for coating wide surfaces) or as a strip-shaped material (for coating narrow surfaces). For this purpose, the coating device 20 shown in FIG. 3 comprises a supply means 80 for the web-shaped or strip-shaped bonding agent 10, in order to feed said bonding agent into the join gap between the workpiece 1 and the coating material 2. In this regard it should be noted that one or more bonding agent components 12, 14 can also be supplied in a web-shaped or strip-shaped form instead of a bonding agent 10.

A further distinctive feature of the embodiment shown in FIG. 3, which does not require a web-shaped or strip-shaped form of the bonding agent 10 either structurally or functionally, however, is the property of the bonding agent 10 of being able to be made adhesive by mechanical force, such as, in particular, by the application of pressure. For this purpose, with the coating device 20 shown in FIG. 3 an increased pressing force F can be applied by means of the pressing roller 24 shown in the drawing to the bonding agent 10 (which can optionally be formed from a plurality of bonding agent components 12, 14), such that the bonding agent 10 develops the desired adhesive effect. For this, substances may be encapsulated in the bonding agent 10, for example, which are released by the application of pressure and which result in an increased adhesive effect.

The embodiment illustrated in FIG. 4 of the device 20 according to the invention is based on the embodiment shown in FIG. 3, but it additionally comprises a means 82 for removing and storing an anti-adhesion cap 16. The reason for this is that in the embodiment shown in FIG. 4, the bonding agent 10 or at least one bonding agent component is already stored in an adhesive state in the means 80 and supplied to the bonding process. In order to prevent self-adhesion of the web-shaped or strip-shaped bonding agent with this concept, the bonding agent 10 or the corresponding bonding agent component has in the stored state an anti-adhesion cap 16. As soon as the adhesive bonding agent 10 has been supplied to the bonding process, the anti-adhesion cap 16 is removed by the means 82 and stored/disposed of or re-used.

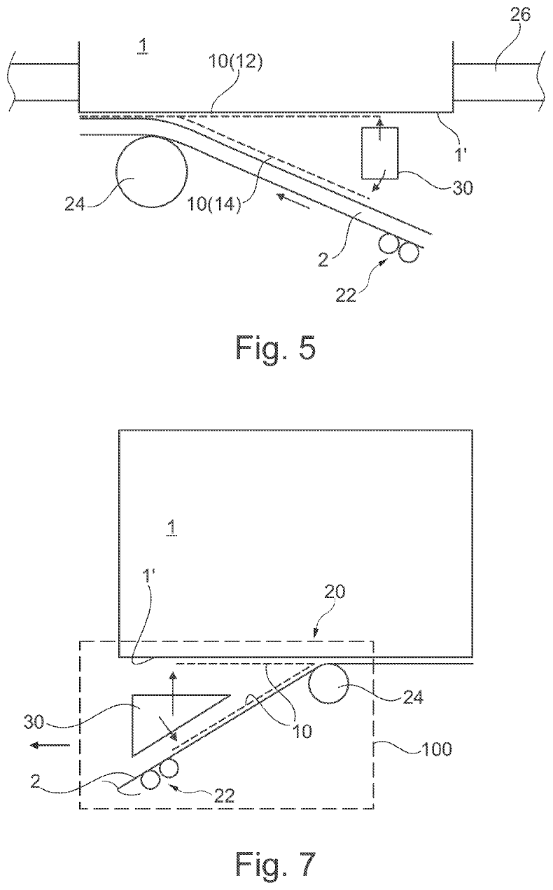

A fourth preferred embodiment of the coating device 20 according to the invention is shown in FIG. 5. This is characterized inter alia in that it comprises a DoD application unit 30, which is configured to apply the bonding agent 10 or at least one bonding agent component to the surface to be bonded of the material 2 and/or to the surface to be coated of the workpiece 1 by means of a drop-on-demand method. The bonding agent or at least one bonding agent component may be, for example, a thermally activatable adhesive such as, in particular, a hot-melt adhesive, which is preferably selected from thermoplastic polyurethane, EVA, polyolefin, polypropylene, polyamide and polyacrylate.

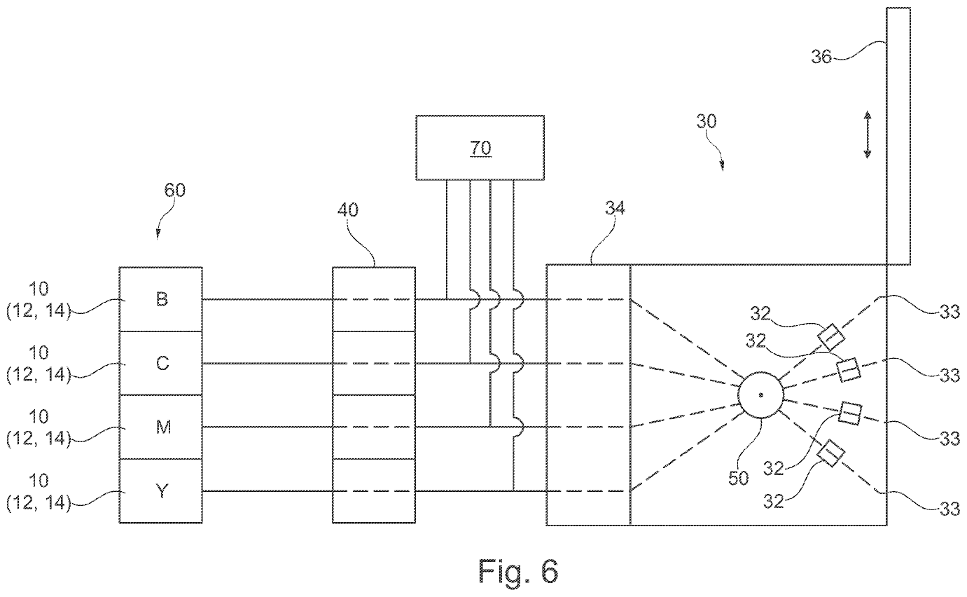

Further details of the DoD application unit 30 and other components linked thereto are schematically shown in FIG. 6. In the present embodiment, the DoD application unit 30 comprises a plurality of microactuators 32 which are configured as piezo actuators, for example, and which are used for discharging the bonding agent 10 or at least one bonding agent component 12, 14 via discharge openings 33. The microactuators 32 are controlled by means of a control device, which is not shown, and can also be controlled individually, so that, where necessary, just some the discharge openings 33 are used for discharging a bonding agent or at least one bonding agent component. This allows, for example, the desired application width of the bonding agent or bonding agent component to be adjusted, optionally in combination with a positional adjustment of the DoD application unit. Furthermore, the selective controllability of the microactuators 32 can also be used to discharge different application amounts through the discharge openings 33, for example to adapt in a targeted manner the application amount to the coating material and/or the workpiece to the respective requirements (such as the porosity of the workpiece or particular imperviousness requirements at the edges).

Although not shown in FIG. 6, the DoD application unit 30 can also comprise discharge openings 33 on different side surfaces, for example to simultaneously provide both the coating material and the workpiece 1 with bonding agent or with the same or different bonding agent components (cf. also FIG. 5). Alternatively, it is, of course, also possible to provide a plurality of independent DoD application units 30.

Moreover, in the present embodiment the DoD application unit 30 comprises a liquefaction means 34, which is used to liquefy supplied bonding agent or at least one supplied bonding agent component by way of heating, thereby adjusting it to the desired viscosity. A further liquefaction or heating unit 40 is arranged upstream of the DoD application unit and also serves to adjust the viscosity of the bonding agent to the respective requirements in a targeted manner, such that overall a multi-stage liquefaction process results in the present embodiment.

Furthermore, in the embodiment shown in FIG. 6, the coating device 20 comprises a supply means 60 for supplying and in the present case also storing a plurality of bonding agents 10 or bonding agent components 12, 14.

In the present embodiment, the supply means 60 contains a plurality of different bonding agents 10 or bonding agent components 12, 14 of different colors, such as black (B), cyan (C), magenta (M) and yellow (Y). However, it is also possible to provide completely different bonding agent categories here, such that different bonding technologies can be alternated between depending on requirements (such as type of workpiece and intended use).

For this reason, the DoD application unit 30 comprises a mixing chamber 50, as shown in FIG. 6, in which the various bonding agents 10 or bonding agent components 12, 14 supplied via the supply means 60 can be mixed in a targeted manner to set the desired color, for example, or to allow bonding agent components to react with one another to form a bonding agent.

In the region of the discharge openings 33, the DoD application unit comprises a sealing means 36 which in the present embodiment is formed as a slider or valve through which the bonding agent contained in the DoD application unit 30, or at least one bonding agent component 12, 14 contained in said bonding agent, can be sealed off from the environment.

Furthermore, a cleaning means 70 is provided, which in the present embodiment is configured as a rinsing means. This is connected to the supply lines of the DoD application unit, such that, where necessary, a rinsing agent or cleaning agent such as a suitable fluid can be supplied and discharged via the discharge openings 33 in order to clean the DoD application unit 30.

The operation of the coating device 20 shown in FIGS. 5 and 6 is carried out as follows, for example. The adhesive 10 stored in the supply means 60 is initially pre-heated in the heating unit 60 to a temperature of 50° C., for example, and is subsequently supplied to the heating means 34 in order to be heated there to a processing temperature of 100° C., for example. In this state, the bonding agent 10 is fed from the various (colored) strands into the mixing chamber 50, in order to set the desired color of the bonding agent or other properties of the bonding agent there depending on the workpiece. Next, by activating the microactuators 32 the bonding agent 10 is applied via the discharge openings 33 to the surface 1′ to be coated of the workpiece 1 and/or to the facing surface of the coating material 2, in order to be present there in a web-shaped or strip-shaped form.

Now, the coating material 2 is pressed onto the surface 1′ to be coated of the workpiece 1 by means of the pressing roller 24. In this stage of the procedure, from forming a web-shaped or strip-shaped bonding agent film or bonding agent component film, no further energy input is required, and therefore there is no need for a separate energy source.

Alternatively or additionally to setting the temperature, the viscosity can also be set in a targeted manner by means of the heating unit 40 and the heating means 34 to advantageous values which, depending on the bonding agent or bonding agent components, may lie in the region of at least 30 mPa s, preferably at least 50 mPa s and/or at most 800 mPa s, preferably at most 500 mPa.

A further embodiment of the coating device 20 according to the invention is schematically shown in FIG. 7 in plan view. This is characterized in that the conveying means, which is not shown in any more detail, serves to move the bonding means 24 along a workpiece 1 which is arranged in a substantially stationary manner (a so-called “stationary machine”). To this end, in the embodiment shown in FIG. 7 a plurality of components such as, in particular, the bonding means 24 and the supply means 22, are arranged on a common carrier 100 which can be moved along the workpiece 1 and optionally also around the workpiece 1. For this, the carrier 100 can be mounted onto a beam-shaped guiding means (not shown) such as a gantry or a cantilever, or also onto a robot arm or the like. The carrier 100 can also be exchanged for a spindle unit 20 of a machining unit arranged on a guiding means, for which tool or machining assemblies can also be exchanged.

In the present embodiment, a DoD application unit 30 is advantageously also arranged on the carrier 100. Depending on the bonding agent technology, this can also be omitted, however.

1. Method for coating a workpiece comprising the steps of:
supplying a coating material to a surface of the workpiece, and
bonding the coating material to the surface using a bonding agent.

2. Method according to claim 1, wherein the bonding agent comprises at least two bonding agent components, with the adhesiveness of the bonding agent being increased by combining the components.

3. Method according to claim 2, wherein at least one first bonding agent component comprises resin.

4. Method according to claim 3, wherein at least one second bonding agent component is selected from gas, comprising air, moisture, hardener and combinations thereof.

5. Method according to claim 4, wherein the bonding agent or at least one bonding agent component comprises a thermally activatable adhesive.

6. Method according to claim 5, wherein the second bonding agent component, is applied to the surface to be coated of the workpiece and/or the surface to be bonded of the coating material.

7. Method according to claim 6, wherein the first bonding agent component, is supplied as a web-shaped or strip-shaped material.

8. Method according to claim 7, wherein the bonding agent is made adhesive by mechanical force.

9. Method according to claim 8, wherein the bonding agent or at least one bonding agent component is stored in an adhesive state and supplied to the bonding process.

10. Method according to claim 9, wherein the adhesive bonding agent is provided in the stored state with an anti-adhesion cap, which is removed before the bonding process is carried out.

11. Method according to claim 10, wherein the adhesive bonding agent is provided on the surface to be bonded of the coating material or as a separate web-shaped or strip-shaped material.

12. Method according to claim 11, wherein the bonding agent or at least one bonding agent component is applied to the surface to be bonded of the coating material and/or the surface to be coated of the workpiece by way of a drop-on-demand method.

13. Method according to claim 12, wherein the bonding agent or at least one bonding agent component has a temperature of at least 30° C.

14. Method according to claim 13, wherein the bonding agent or at least one bonding agent component has a viscosity of at least 30 mPa s.

15. Method according to claim 14, wherein the bonding agent or at least one bonding agent component is brought into a web-shaped or strip-shaped form prior to bonding and subsequently, in the course of the further bonding process, is no longer supplied with thermal energy.

16. Method according to claim 15, wherein the bonding agent or at least one bonding agent component is brought into a web-shaped or strip-shaped form prior to bonding, which form has a mass per unit area of at most 150 g/m2.

17. Device for coating a workpiece for carrying out the method according to claim 1, comprising
a means for supplying a coating material to a surface to be coated of the workpiece,
a means for bonding the coating material to the surface to be coated using a bonding agent, and
a conveying means for causing a relative movement between the workpiece and the bonding means.

18. Device according to claim 17, wherein the device comprises a DoD application unit which is configured to apply the bonding agent or at least one bonding agent component to the surface to be bonded of the coating material and/or the surface to be coated of the workpiece by way of a drop-on-demand method.

19. Device according to claim 18, wherein the DoD application unit comprises at least one microactuator for discharging the bonding agent or at least one bonding agent component.

20. Device according to claim 19, wherein the DoD application unit comprises a liquefaction means which is configured to increase the viscosity of the bonding agent or at least one bonding agent component.

21. Device according to claim 20, wherein the device further comprises a liquefaction unit upstream of the DoD application unit, which unit is configured to increase the viscosity of the bonding agent or at least one bonding agent component.

22. Device according to claim 21, wherein the device further comprises a sealing means for sealing off the bonding agent or at least one bonding agent component contained in the DoD application unit from the environment.

23. Device according to claim 22, wherein the device further comprises a mixing means for mixing a plurality of supplied bonding agents or bonding agent components.

24. Device according to claim 23, wherein the device comprises a supply means for supplying and storing at least one bonding agent or at least one bonding agent component.

25. Device according to claim 24, wherein the supply means supplies a plurality of bonding agents or bonding agent components having different properties.

26. Device according to claim 25, wherein the device further comprises a cleaning means for the DoD application unit.
